(19) United States
(12) Patent Application Publication
(10) Pub. No.: US 2013/0016377 A1
(43) Pub. Date: Jan. 17, 2013

(54) SYSTEM AND METHOD FOR AUTOMATIC RECOVERY OF CLOUD PRINT JOBS AFTER PRINTER ERROR

(71) Applicant: Somasundaram Meiyappan, Singapore (SG)

(72) Inventor: Somasundaram Meiyappan, Singapore (SG)

(21) Appl. No.: 13/548,045

(22) Filed: Jul. 12, 2012

Related U.S. Application Data
(60) Provisional application No. 61/508,495, filed on Jul. 15, 2011.

(51) Int. Cl. H04N 1/60; G06K 15/02

(52) U.S. Cl. 358/1.9; 358/1.14

(57) ABSTRACT

A system for automatic recovery of cloud print jobs after printer error. A cloud printing system for transmitting a print job to a printer. A printer control system for receiving status data from the printer and modifying one or more control parameters of the cloud printing system in response to the status data.

### RELATED APPLICATIONS

The present applications claims priority to U.S. Provisional patent application No. 61/508,495, which was filed on Jul. 15, 2011, and which is hereby incorporated by reference for all purposes.

### TECHNICAL FIELD

The present disclosure relates to printing services, and more specifically to automatic recovery of print jobs from a cloud print server after a printer error.

### BACKGROUND OF THE INVENTION

Cloud printing services are known in the art. Such services include the Google cloud printing service, which allows a user having an Internet-enabled device to send a print job to a printer that is connected to the Internet. However, because of the nature of the Internet connection, little or no control over the printer is available.

### SUMMARY OF THE INVENTION

In accordance with an exemplary embodiment of the present disclosure, a system and method for automatic recovery of cloud print jobs after printer error is provided that allows a printer that receives print jobs from a cloud print server to recover from printer faults, such as paper jams or other errors, without the need to restart the print job from the first page.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for providing printer control in a distributed printing environment in accordance with an exemplary embodiment of the present disclosure;

FIG. 2 is a diagram of printer control system in accordance with an exemplary embodiment of the present disclosure;

FIG. 3 is a diagram of printer interface system in accordance with an exemplary embodiment of the present disclosure;

FIG. 4 is a diagram of device printer control system in accordance with an exemplary embodiment of the present disclosure; and

FIG. 5 is a diagram of an algorithm for providing control in a cloud printing environment in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

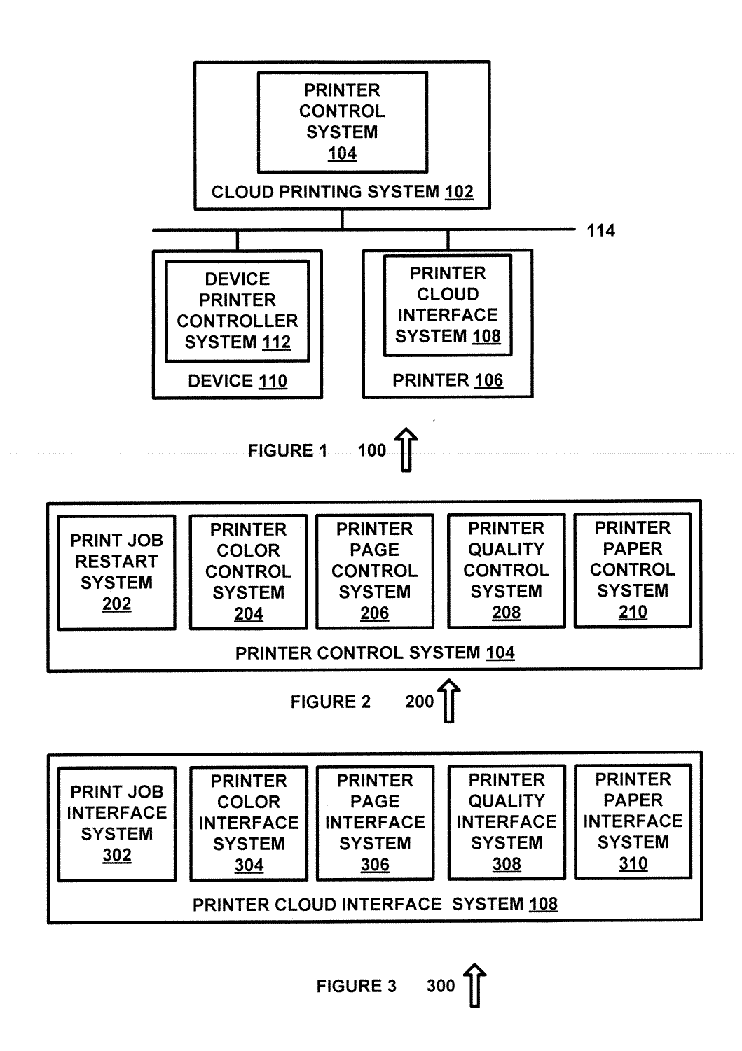

FIG. 1 is a diagram of a system 100 for providing printer control in a distributed printing environment in accordance with an exemplary embodiment of the present disclosure. System 100 allows a print job to be restarted when the print job has been interrupted and provides additional user control features.

System 100 can be implemented in hardware or a suitable combination of hardware and software, and can be one or more software systems operating on a processor. As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

System 100 includes device 110, which is a suitable device that can request a print job, such as a computer, a cell phone, a digital camera, a notebook computer, a tablet computer, or other suitable devices. Device 110 is coupled to cloud printing system 102 by communications medium 114. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. Cloud printing system 102 can be a cloud printing service such as the Google cloud printing service or other suitable printing services, such as a printing service that is configured to receive data over a network that is addressed from a device or system and to route the data to a printer that is connected to the network, such as through the use of a printer network address that is selected by the device or system, that is associated with the device or system, or in other suitable configurations. Communications medium 114 can be the Internet, a wireless network or communications medium, a wire line network or communications medium, a point to point communications medium such as infrared or data cables, a fiber optic network or communications medium, a suitable combination of communications media or other suitable communications media. Device 110 includes device printer controller system 112, which allows a user of device 110 to exercise control over printer 106.

Printer 106 can be an Internet-connected printer or other suitable printers, and includes printer cloud interface system 108. Printer 106 is coupled to cloud printing system 102 by communications medium 114. Printer cloud interface system 108 allows printer 106 to communicate control data and other suitable data to cloud printing system 102.

Cloud printing system 102 includes printer control system 104, which provides error handling and other printer control functionality. In one exemplary embodiment, error data can be generated by a printer when a print job fails to print to completion, such as when the paper jams, when the paper runs out, when the ink runs out, or for other possible reasons. In this exemplary embodiment, one or more error codes can be generated by the printer and transmitted to the device that requested the print job, such as in a suitable data frame format.

When interacting with a cloud printing service, the printer can pull data from the server by using a http/https GET method and associated algorithms and protocols. When the printer prints from the print data stream, errors can be encountered. Some errors like printer jams can happen when a page is being printed and typically, in low-to-mid-end printers that have limited memory, memory that was used to store data that defines the part of the page that has been printed on the “jammed” paper is typically de-allocated. When this occurs, after the user clears the paper jam the printer is unable to print the “jammed” page again as it has lost the data that defines the content that is to be printed. Hence, in low-to-mid end printers, paper jam recovery is not accommodated by the printer.

Since the printer driver or other printer control systems can determine the page that did not print properly as a consequence of such errors, those systems can be used to determine the N number of pages that have been printed successfully, where N is an integer greater than zero. The present disclosure provides an application, system, algorithm or other suitable mechanism, such as into the cloud print application programming interfaces (APIs) provided by the cloud print service provider or in other suitable system components, such that the printer can transmit data to the print server (or the print server can transmit data to the printer) that it identifies that the content that corresponds to the first N pages does not need to be retransmitted. In this manner, the cloud print service provider can send data corresponding to pages starting from page ‘N+1’ onwards, and the printer can start recovering from printer errors (such as paper-jams, out of ink conditions, out of paper conditions, or other errors) automatically and without the need for the user to monitor the status of the print job, to re-initiate the print job, or to take other actions. In this exemplary embodiment, all of the data that is required to complete the print job is already present in its entirety in the cloud and is utilized, and can be accessed multiple times until the printer transmits data to the cloud print service provider that indicates that the printer has completed printing of the print job.

The importance of automatic recovery can be utilized in a cloud print solution as the sender of the print job is not necessary actively monitoring the status of the print job to resend the print job manually again through the cloud service. Automatic job recovery will allow the cloud print service to adopt a ‘submit and forget’ model in which the job that is submitted once will be printed irrespective of the kind of recoverable errors that the printer may encounter. This disclosure is also applicable to other settings, such as paper settings, color settings, or other defaults to be used when errors are encountered (such as for paper, color, print quality), or other suitable conditions.

In one exemplary embodiment, the cloud print system can generate data that instructs the printer to retrieve the contents of the print job by accessing the fileURL, which can take the form: https://www.cloudprintserver.com/download?id=5930228722414108220 In this exemplary embodiment, an http GET command can be used with the fileURL to specify the format in which the content can be converted into by the cloud printer server before responding to the HTTP GET command.

In an exemplary embodiment of the present invention, for recovering from a printer error or for other suitable purposes, an extra argument can be appended to the fileURL, such as: http://www.cloudprintserver.com/download?id=5930228722414108220& startpage=5, where the content can be converted into the requested format from page 5 onwards if HTTP GET is used. Alternatively, this argument can take the form of a custom HTTP header field or data field (not a HTTP header field) in the HTTP POST data. Likewise, other suitable printer control data can be provided in a similar manner, such as to control color settings, to change color settings if ink is depleted, to change paper settings, to change a paper source if the desired paper source is depleted, to change quality/dots per inch settings, to change the number of images shown on a page, to select an alternate printer, or for other suitable control settings.

When the source document has been composed of pages already, the cloud printing service can start the file-format conversion process from the page defined by ‘startpage’ data and onwards before responding to the client's HTTP GET/POST command on the fileURL.

When the source document is formatted as a continuous document, such as an HTML page or other continuous data formats, one of several different configurations can be applied. In one configuration, if the renderer (i.e., the file-format converter) uses the viewports to directly obtain the data that defines the contents of a page, as a function of the target paper size and printable area, then objects can be identified that are part of the ‘startpage’ page and can be used to start rendering the objects into the first page of the returned document.

In another configuration, if the renderer/file-format converter composes each preceding page before it identifies how the page that corresponds to ‘startpage’ can be formed according the printable area defined by data associated with the job ticket, then the converter/renderer can perform a ‘dry run’ of the rendering operation of all objects that do not overlap with the printable area of the page denoted by ‘startpage’ followed by the committed rendering of the objects that are to be printed for ‘startpage’ and can generate the output through the defined printable area as its viewport. Subsequent pages can be generated as normal.

In another configuration, if the renderer/file-format converter composes and renders each preceding page before it generates the data for the page denoted by ‘startpage’, then the service can compose and render all pages and ignore the generated contents of all pages preceding the page denoted by ‘startpage’.

In these and other suitable configurations, the file-header/magic information that may precede all pages may need to be provided when the source document is converted into the requested output format. If the requested format requires a page header, then the header of the page that corresponds ‘startpage’ can also be provided between the file-header/magic and the contents of the page denoted by ‘startpage’.

On the printer side, the value of ‘startpage’ can be identified from where data should be resent by the cloud service. This value can depend upon the number of pages printed on a side of paper (usually referred to as N-up) and whether the hard-copy output expected is simplex (print on only one side of the paper) or duplex (print on either side of the paper).

In some embodiments, the page order of the output of the file-format converter can be the reverse of the order of the pages in the source document i.e., an M page source document may be sent to the printer with page M first, page M−1 next, and so forth, where M is an integer greater than zero. In this exemplary embodiment, if the startpage parameter is specified, then the first page sent to the printer by the cloud print service can be page M−startpage+1 followed by page M−startpage, M−startpage−1, and so forth.

FIG. 2 is a diagram of printer control system 200 in accordance with an exemplary embodiment of the present disclosure. Printer control system 200 includes printer control system 104 and print job restart system 202, printer color control system 204, printer page control system 206, printer quality control system 208 and printer paper control system 210, each of which can be implemented in hardware or a suitable combination of hardware and software, and which can be one or more software systems operating on a processor.

Print job restart system 202 error data from a printer, print job data from a device or other suitable systems or other suitable data and generates data to restart a printer print job where error data has been generated and received, such as when a paper jam occurs, where the printer runs out of paper, or when other conditions arise that cause the printer to generate error data and transmit the error data to the cloud printing system or other suitable systems. Print job restart system 202 can receive the error data restart printing at a predetermined page number, can determine the correct page to restart at, such as based on the error data, determine the correct page to restart at when unformatted material is being printed (such as in the manner previously discussed or in other suitable manners), or can perform other suitable functions.

Printer color control system 204 error data from a printer, print job data from a device or other suitable systems or other suitable data and generates the color of a printer print job, such as where error data has been received from the printer or other suitable sources (printer out of ink), to provide different qualities of service (such as to provide control data to increase or decrease a dots per inch (DPI) or other print quality setting), or for other suitable purposes.

Printer color control system 204 can generate control data that causes the printer to change color during a print job (such as to change to an available color in response to data that indicates that the printer ran out of ink having a different color), or can perform other suitable functions.

Printer page control system 206 error data from a printer, print job data from a device or other suitable systems or other suitable data and generates control data for a printer to control pagination of a printer print job, such as to print on both sides of paper, to print multiple images on a single sheet of paper, or for other suitable purposes. In one exemplary embodiment, printer page control system 206 can receive control data from a user device, system or other suitable sources and can generate control data for transmission to a printer to provide for temporary printer page control settings (such as to change settings for the current print job and to return the settings to their original values after the print job finishes), can query a printer for data defining page control presets and can generate suitable control data for a print job to change the presents as a function of data received from a device or systems, and can perform other suitable functions.

Printer quality control system 208 receives error data from a printer, print job data from a device or other suitable systems or other suitable data and generates control data to control print quality, such as dots per inch settings or other suitable settings of a printer for a print job, and to provide quality of service settings or for other suitable purposes. In one exemplary embodiment, print quality control system 208 can receive error data, printer configuration data or other suitable data and can generate control data to change printer quality settings, such as in response to an error message, based on predetermined default settings for a user, to override printer default settings, or to perform other suitable functions.

Printer paper control system 210 error data from a printer, print job data from a device or other suitable systems or other suitable data and generates control data to control the type of paper used by a printer for a print job, such as to select a different paper type in response to error data indicating that the printer has run out of paper. Printer paper control system 210 can change paper type settings in the middle of print job, such as to restart printing with a different paper size after receiving error data from the printer that indicates that the printer is out of paper, can override printer default settings, or can perform other suitable functions.

FIG. 3 is a diagram of printer interface system 300 in accordance with an exemplary embodiment of the present disclosure. Printer interface system 300 includes printer cloud interface system 108 and print job interface system 302, printer color interface system 304, printer page interface system 306, printer quality interface system 308 and printer paper interface system 310, each of which can be implemented in hardware or a suitable combination of hardware and software, and which can be one or more software systems operating on a printer controller.

Print job interface system 302 receives restart data from a cloud printing service and generates control data to restart a printer print job where error data has been generated, such as when a paper jam occurs, where the printer runs out of paper or in other situations where the printer generates error data and transmits the error data to a cloud printing service. Print job interface system 302 can receive control data from the cloud printing service and can generate control data to cause the printer to restart the print job at a predetermined page number, can receive control data to determine the correct page to restart at for unformatted material, or can perform other suitable functions.

Printer color interface system 304 receives color control data from a cloud printing service and generates control data to change ink colors for a printer print job where error data has been generated allows a printer that is connected to a cloud printing service to control the color of a printer print job, such as where an error has been received (printer out of ink), to provide different qualities of service (such as in response to user configuration settings), or for other suitable purposes. Printer color interface system 304 can receive control data to change color during a print job, can determine a correct page to restart printing at for unformatted material, or can perform other suitable functions.

Printer page interface system 306 receives control data from a cloud printing service to control pagination of a printer print job, such as to print on both sides of paper, print multiple images on a single sheet of paper, or for other suitable purposes. Printer page interface system 306 can provide temporary printer page control settings (such as in response to control data after error data has been generated), can respond to page control presets at a printer, or can perform other suitable functions.

Printer quality interface system 308 receives control data from a cloud printing service to control printer print quality settings, such as dots per inch settings of a printer print job, such as to provide quality of service settings or for other suitable purposes. Print quality interface system 308 can change the quality settings in the middle of a print job (such as in response to control data after error data has been generated), can override printer default settings, or can perform other suitable functions.

Printer paper interface system 310 receives control data from a cloud printing service and to control the type of paper used by a printer for a print job. Printer paper interface system 310 can change paper type settings in the middle of print job (such as in response to control data after error data has been generated), can override printer default settings, or can perform other suitable functions.

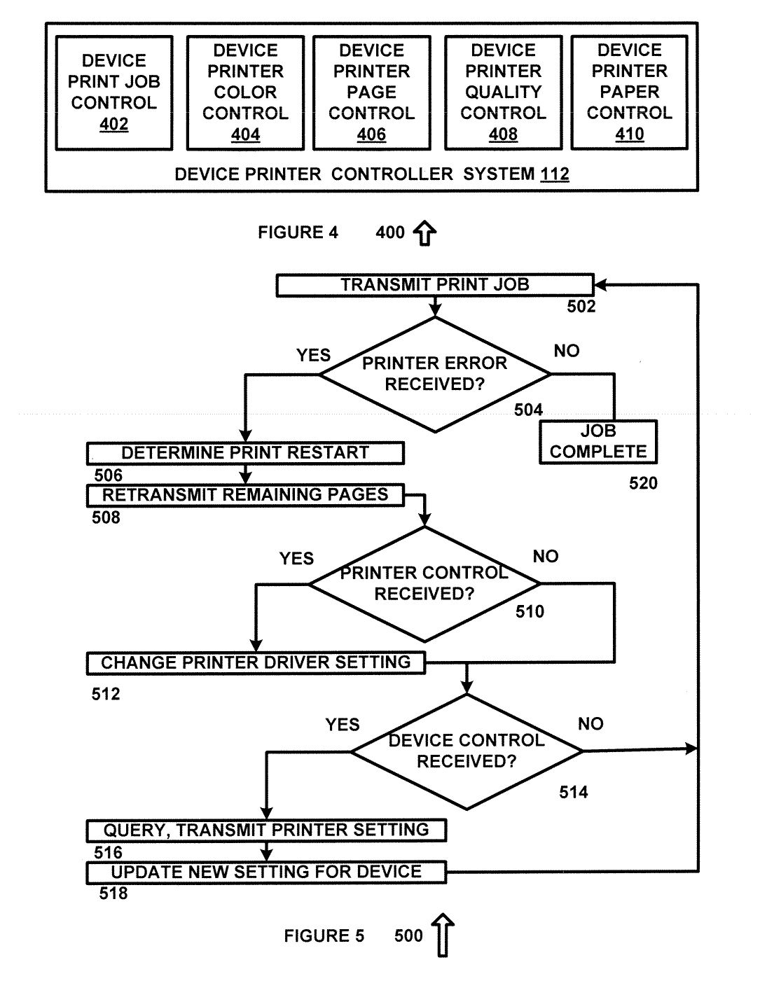

FIG. 4 is a diagram of device printer control system 400 in accordance with an exemplary embodiment of the present disclosure. Device printer control system 400 includes device printer controller system 112 and device print job control 402, device printer color control 404, device printer page control 406, device printer quality control 408 and device printer paper control 410, each of which can be implemented in hardware or a suitable combination of hardware and software, and which can be one or more software systems operating on a device controller.

Device print job control 402 generates data for transmission to a cloud printing service or printer to restart a printer print job where error data has been received, such as when a paper jam occurs, where the printer runs out of paper, or in other suitable circumstances. Device print job control 402 can generate data to cause the printer to restart at a predetermined page number, can determine the correct page to restart at for unformatted material and generate data to cause the printer to restart at the correct page, or can perform other suitable functions.

Device printer color control 404 generates data for transmission to a cloud printing service or printer to control the color of a printer print job, such as in response to error data (printer out of ink), to provide different qualities of service, or for other suitable purposes. Device printer color control 404 can change color during a print job (such as in response to error data received during printing), or can perform other suitable functions.

Device printer page control 406 generates data for transmission to a cloud printing service or printer to control pagination of a printer print job, such as to print on both sides of paper (such as in response to a low paper indication), to print multiple images on a single sheet of paper, or for other suitable purposes. Device printer page control 406 can receive error data from a printer or cloud printing service and can generate temporary printer page control settings, can respond to page control presets at a printer, or can perform other suitable functions.

Device printer quality control 408 generates data for a cloud printing service or printer to control printer quality settings, such as dots per inch settings of a printer print job, to provide quality of service settings or for other suitable purposes. Device print quality control 408 can receive error data from a printer or cloud printing service and can generate data to change the quality settings in the middle of a print job (such as in response to the error data), can override printer default settings, or can perform other suitable functions.

Device printer paper control 410 generates data for a cloud printing service or printer to control the type of paper used by a printer for a print job. Device printer paper control 410 can receive error data from a printer or cloud printing service and can generate data to change paper type settings in the middle of print job (such as in response to error data), can override printer default settings, or can perform other suitable functions.

FIG. 5 is a diagram of an algorithm 500 for providing control in a cloud printing environment in accordance with an exemplary embodiment of the present invention. Algorithm 500 can be implemented in hardware or a suitable combination of hardware and software, such as one or more software systems operating on a processor.

Algorithm 500 begins at 502 where a print job is transmitted to a printer in a cloud printing service, such as from a wireless device to an Internet-connected printer. In one exemplary embodiment, a print control algorithm for the device or system that is transmitting the algorithm can be implemented, such as in response to receipt of a user control to initiate printing for a predetermined document, web page, file, item or other suitable data. The algorithm then proceeds to 504.

At 504, it is determined whether a printer error data has been received. In one exemplary embodiment, the printer error can be a data message in a predetermined data format containing one or more fields that contain data that identifies a paper jam error, an cut of paper error, or other suitable error data. An algorithm operating on the device or system that generated the print job can receive and parse the data message to extract the error data fields, can use a look-up table or other suitable procedures for determining the contents of the error data fields, or other suitable processes can also or alternatively be used. If it is determined at 504 that no printer error data has been received, the algorithm proceeds to 520 and the status of the print job is updated to reflect that the print job has completed, otherwise the algorithm proceeds to 506 where a print restart point is determined. In one exemplary embodiment, the print restart point can be determined at the cloud printing server, at the printer, at the device or system that generated the print request, or in other suitable manners, such as by receiving error data that contains data that identifies a print restart point in a predetermined data field.

In this exemplary embodiment, the error data can identify the last page number that was successfully printed, the next page number where printing should be re-initiated, or other suitable data. The algorithm then proceeds to 508 where the remaining pages are transmitted, if necessary, such as by the cloud printing service. The algorithm then proceeds to 510.

At 510, it is determined whether printer control data has been received. In one exemplary embodiment, the printer control data can include one or more data fields generated by the cloud printer server, such as data fields that are configured to control the color, paper type, number of images per page, or other suitable settings of the printer, where the algorithm parses a data message and extracts the predetermined data fields if they are present. The printer control data can also be generated by the printer, such as in response to a printer default setting, a loss of ink, a change in paper supply, or in response to other suitable data. If it is determined that no printer control data has been received, the algorithm proceeds to 514. If it is determined that printer control has been received, the algorithm proceeds to 512 where a predetermined printer driver control setting is changed in the cloud printer driver, such as by activating a predetermined cloud printer driver algorithm, by using a cloud printer driver Application Program Interface (API) setting, or in other suitable manners. The Algorithm then proceeds to 514.

At 514, it is determined whether device control data has been received, such as printer setting control data that can be included in a data message received from the device or other suitable components or systems. In one exemplary embodiment, a device can include hardware or a suitable combination of hardware and software that changes printer setting data to control the paper type, a number of images per page, dots per inch print quality, or other suitable data settings. If it is determined that no device control data has been received, such as by parsing a data message and determining whether one or more data fields of the data message contain printer control data, the algorithm returns to 502. Otherwise, the algorithm proceeds to 516 where the printer setting can be queried and transmitted. In one exemplary embodiment, a device can be used to select a printer that has the appropriate paper, ink, or other capabilities, such as by accessing a look-up table that identifies predetermined available printers and their associated capabilities in one or more predetermined data fields, and the printer settings can be transmitted to the device for that purpose or other suitable purposes. The algorithm then proceeds to 518, where new setting data is provided by the cloud printing service. In one exemplary embodiment, the setting data for the device can be stored in the cloud printer server, so that the device has associated printer default values that are used to configure the printer for print jobs generated by that device.

In algorithm 500 or elsewhere, printer control settings can be provided or selected using URL data fields, as described herein. Although algorithm 500 is depicted as a flow chart algorithm, algorithm 500 can also or alternatively be implemented as a state machine, using object-oriented programming, or in other suitable manners.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for automatic recovery of cloud print jobs after printer error, comprising:
a cloud printing system configured to receive a print job over a network from a device and to transmit the print job to a printer; and
a printer control system configured to receive status data from the printer and to modify one or more control parameters of the cloud printing system in response to the status data, wherein the cloud printing system transmits data to the printer in response to the modified control parameters.

2. The system of claim 1 wherein the printer control system comprises a print job restart system configured to transmit data to the printer to restart a print job from a predetermined page of the print job that is after the first page of the print job.

3. The system of claim 1 wherein the printer control system comprises a printer color control system configured to select printer color control setting data in response to the status data and to transmit the printer color control setting data to the printer.

4. The system of claim 1 wherein the printer control system comprises a printer page control system configured to select setting data for a number of images to print on each page in response to the status data and to transmit the setting data to the printer.

5. The system of claim 1 wherein the printer control system comprises a printer quality control system configured to select dots per inch setting data of the printer in response to the status data and to transmit the setting data to the printer.

6. The system of claim 1 wherein the printer control system comprises a printer paper control system configured to select paper size data for the printer in response to the status data and to transmit the paper size data to the printer.

7. The system of claim 1 further comprising a printer cloud interface system configured to transmit printer status data to the printer control system.

8. The system of claim 1 further comprising a device printer controller system configured to generate data to enable the device to select printer control settings using the printer control system.

9. A method for automatic recovery of cloud print jobs after receipt of printer error data, comprising:
receiving electronic print job data from a device at a cloud printing service over a network;
transmitting the electronic print job data from the cloud printing service to a remote printer over the network;
receiving an error message from the remote printer at the cloud printing service that includes a page restart indicator;
reformatting the print job to start printing at a page indicated by the page restart indicator; and
transmitting the reformatted print job to the printer over the network.

10. The method of claim 9 wherein receiving the error message comprises receiving a data field in a uniform resource locator.

11. The method of claim 9 wherein reformatting the print job comprises:
rendering a document as a continuous document;
determining a point within the document corresponding to the page restart indicator; and
reformatting the print job to start at the point within the document corresponding to the page restart indicator.

12. The method of claim 9 wherein reformatting the print job comprises transmitting control data to the remote printer to change a predetermined printer setting.

13. The method of claim 9 wherein reformatting the print job comprises:
retrieving one or more default settings from a user profile; and
transmitting control data to the remote printer to change a predetermined printer setting.

14. The method of claim 9 wherein reformatting the print job comprises transmitting control data to the remote printer to change a printer ink setting.

15. The method of claim 9 wherein reformatting the print job comprises transmitting control data to the remote printer to change a print quality setting.

16. The method of claim 9 wherein reformatting the print job comprises transmitting control data to the remote printer to change a printer paper type setting.

17. The method of claim 9 further comprising:
receiving a second error message from the remote printer at the cloud printing service that includes a second page restart indicator;
reformatting the print job to start at a second page indicated by the second page restart indicator; and
transmitting the reformatted print job to the printer.

18. A system for automatic recovery of cloud print jobs after printer error, comprising:
a cloud printing system configured to receive a print job from a device over a network and to transmit the print job to a printer over the network; and
a printer control system configured to receive error data from the printer, to modify one or more control parameters of the printer in response to the error data, and to transmit the control parameters to the printer.

19. The system of claim 18 wherein the printer control system comprises a print job restart system configured to restart a print job from a selected page of the print job in response to the error data.

20. The system of claim 18 wherein the printer control system comprises a printer color control system configured to select printer color control settings in response to the error data.
